(19) United States
(12) Patent Application Publication
(10) Pub. No.: US 2010/0276209 A1
(43) Pub. Date: Nov. 4, 2010

(54) Roller Cones, Methods of Manufacturing Such Roller Cones, and Drill Bits Incorporating Such Roller Cones

(75) Inventors: Zhou Yong, Spring, TX (US); Sike Xia, Pearland, TX (US)

Correspondence Address: SMITH INTERNATIONAL INC.;Patent Services, 1310 Rankin Rd., HOUSTON, TX, 77073, US

(73) Assignee: SMITH INTERNATIONAL, INC., Houston, TX (US)

(21) Appl. No.: 12/773,164

(22) Filed: May 4, 2010

Related U.S. Application Data
(60) Provisional application No. 61/175,148, filed on May 4, 2009.

(51) Int. Cl. E21B 10/50; E21B 10/08; B05D 1/10

(52) U.S. Cl. 175/374; 427/446; 427/450

(57) ABSTRACT

A roller cone drill bit having a layer of wear resistant material applied thereon utilizing a thermal spray process and methods of manufacturing such drill bits.

### CROSS-REFERENCE TO RELATED APPLICATIONS

This application claims priority to U.S. Provisional Application No. 61/175,148, filed May 4, 2009, which is hereby incorporated by reference in its entirety.

### FIELD OF THE INVENTION

The invention relates generally to the field of drill bits used to bore holes through earthen formations. More particularly, the invention relates to methods and structures for improving the performance and/or cost effectiveness of roller cone drill bits.

### BACKGROUND OF THE INVENTION

Drill bits used to bore wellbores or boreholes through earthen formations include roller cone drill bits. Typical roller cone bits include a bit body made from steel or similar material. The bit body includes one or more, typically three, legs which are welded together to form the bit body. The bit body is typically adapted to be coupled to a drilling tool assembly (“drill string”) which rotates the bit body during drilling. The legs include a journal onto which a roller cone is rotatably mounted. The roller cone typically includes a plurality of cutting elements disposed at selected positions about the surface of the cone. The cutting elements are typically of two types: inserts formed of a very hard material, such as sintered tungsten carbide, that are press fit into undersized apertures formed in the cone surface; or generally triangular teeth that are milled, cast, or otherwise integrally formed from the material of the roller cone. Bits having tungsten carbide inserts (formed by sintering a tungsten carbide and a binder) are typically referred to as “TCI” bits, while those having teeth formed from the cone material are known as “milled tooth bits.” In each case, the cutting elements on the rotating roller cones functionally breakup the formation to form a borehole by a combination of gouging and scraping or chipping and crushing. This action wears the surface of the cutting elements.

In many types of roller cone drill bits, the roller cone is sealed with respect to the journal to exclude fluids and debris from the wellbore from entering the journal. The seal element is often an elastomer ring or similar device. A lubricant reservoir is also typically included to provide a lubricant to the bearing surface. The lubricant is typically some form of petroleum-based grease or the like.

Typical roller cone drill bits also include therein fluid discharge nozzles. The discharge nozzles provide a path for discharge of drilling fluid from the interior of the drilling tool assembly to cool, lubricate and clean the roller cones, and to lift formation cuttings out of the wellbore as the wellbore is being drilled. Often, such drilling fluid is circulated through the wellbore at high rates to enable adequate lifting of drill cuttings which can wear the surfaces of the drill bit.

For TCI-type roller cone bits, there is generally a trade-off between the insert length that can be attached within the roller cone aperture and the size of the journal and seal assembly that can fit within the interior of the roller cone. The greater the depth the insert is placed within the roller cone the greater the extension height above the surface the insert can have, thus, increasing the rate of penetration (ROP) of the bit. However, such an increase usually requires sacrificing the space available within the interior of the roller cone for the journal and seal assembly which can limit bit life.

The cost of drilling a wellbore is proportional to the length of time it takes to drill to the desired depth and location. The time required to drill the well, in turn, is greatly affected by the number of times the worn drill bit must be changed in order to reach the targeted formation. This is the case because each time the bit is changed, the entire string of drill pipe, which may be miles long, must be retrieved from the wellbore, section by section. Once the drill string has been retrieved and the new bit installed, the bit must be lowered to the bottom of the wellbore on the drill string, which again must be constructed section by section. This process, known as a “trip” of the drill string, requires considerable time, effort and expense.

Accordingly, it is always desirable to employ drill bits which will drill faster and longer and which are more cost effective and usable over a wider range of formation hardnesses.

### SUMMARY OF THE INVENTION

In one aspect, one or more embodiments of the present invention relate to a method for manufacturing a roller cone comprising forming a cone which comprises a plurality of parent cutting elements spaced about the exterior surface of the body; applying a layer of wear resistant material to at least a portion of at least one of the parent elements utilizing a thermal spray process; and sintering the layer of wear resistant material. In other aspects, the present invention relates to a roller cone prepared according to such method and a drill bit incorporating such a roller cone.

In another aspect, one or more embodiments of the present invention relate to a roller cone comprising a cone body which comprises a plurality of parent cutting elements having at least two layers applied on at least a portion of at least one of the parent elements. The at least two layers comprise an outer layer and a first intermediate layer positioned between the surface of the parent element and the outer layer; and at least one of the layers comprises a wear resistant material and is applied utilizing a thermal spray process. In other aspects, the present invention relates to a method of manufacturing such a roller cone and a drill bit incorporating such a roller cone.

In yet another aspect, one or more embodiments of the present invention relate to a roller cone comprising a cone body which comprises a plurality of inserts and a plurality of parent cutting elements having a layer of wear resistant material applied on at least a portion of at least one of the parent elements by a thermal spray process. In other aspects, the present invention relates to a method of manufacturing such a roller cone and a drill bit incorporating such a roller cone.

In yet another aspect, one or more embodiments of the present invention relate to a drill bit comprising a bit body having at least one leg extending therefrom; and a roller cone cutter rotatably mounted on the leg. At least a portion of the surface of the bit comprises a layer of a wear resistant material applied utilizing a thermal spray process.

Other aspects and advantages of the invention will be apparent from the following description and the appended claims.

### BRIEF DESCRIPTION OF THE DRAWINGS

FIG. 1 is a perspective view of an embodiment of an earth-boring bit made in accordance with the principles described herein;

FIG. 2 is a partial cross-sectional view taken through one leg and one rolling cone cutter of a drill bit as shown in FIG. 1;

FIG. 3 is a perspective view of one roller cone cutter of the bit of FIG. 1;

FIG. 4 is a perspective view of an embodiment of an earth-boring bit made in accordance with the principles described herein;

FIG. 5 is a partial cross-sectional view taken through one leg and one rolling cone cutter of a drill bit as shown in FIG. 4;

FIG. 6 is a an enlarged cross sectional view of a milled tooth cutting element of a roller cone cutter shown in FIGS. 4 and 5 according to an embodiment of the present disclosure;

FIG. 7 is a scanning electron microscope (SEM) image of a milled tooth cutting element of a roller cone cutter according to an embodiment of the present disclosure;

FIG. 8 is a an enlarged cross sectional view of a milled tooth cutting element of a roller cone cutter shown in FIGS. 4 and 5 according to another embodiment of the present disclosure;

FIG. 9 is a an enlarged cross sectional view of a milled tooth cutting element of a roller cone cutter shown in FIGS. 4 and 5 according to another embodiment of the present disclosure; and

FIG. 10 is a partial cross-sectional view taken through one leg and one rolling cone cutter of a drill bit similar to FIG. 1.

### DETAILED DESCRIPTION

In one aspect, embodiments disclosed herein relate to improved roller cones for mounting on a drill bit. In particular, one or more embodiments disclosed herein relate to roller cones, methods of manufacturing such roller cones, and drill bits incorporating such roller cones. Roller cones of the present disclosure having a layer of wear resistant material applied thereon by a thermal spray process can exhibit an improvement in one or more properties such as rate of penetration (ROP), bit life and/or cost effectiveness.

The following disclosure is directed to various embodiments of the invention. The embodiments disclosed have broad application, and the discussion of any embodiment is meant only to be exemplary of that embodiment, and not intended to intimate that the scope of the disclosure, including the claims, is limited to that embodiment or to the features of that embodiment.

Certain terms are used throughout the following description and claims to refer to particular features or components. As one skilled in the art will appreciate, different persons may refer to the same feature or component by different names. This document does not intend to distinguish between components or features that differ in name only. The drawing figures are not necessarily to scale. Certain features and components herein may be shown exaggerated in scale or in somewhat schematic form and some details of conventional elements may not be shown in the interest of clarity and conciseness.

In the following description and in the claims, the terms “including” and “comprising” are used in an open-ended fashion, and thus, should be interpreted to mean “including, but not limited to . . . .”

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, quantities, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of 1 to 4.5 should be interpreted to include not only the explicitly recited limits of 1 to 4.5, but also include individual numerals such as 2, 3, 4, and sub-ranges such as 1 to 3, 2 to 4, etc. The same principle applies to ranges reciting only one numerical value, such as “at most 4.5”, which should be interpreted to include all of the above-recited values and ranges. Further, such an interpretation should apply regardless of the breadth of the range or the characteristic being described.

As used herein, the mesh sizes refer to standard U.S. ASTM mesh sizes. The mesh size indicates a wire mesh screen with that number of holes per linear inch, for example a “16 mesh” indicates a wire mesh screen with sixteen holes per linear inch, where the holes are defined by the crisscrossing strands of wire in the mesh. The hole size is determined by the number of meshes per inch and the wire size. When using ranges to describe sizes of particles, the lower mesh size denotes (which may also have a “−” sign in front of the mesh size) the size of particles that are capable of passing through an ASTM standard testing sieve of the smaller mesh size and the greater mesh size denotes (which also may have a “+” sign in front of the mesh size) the size of particles that are incapable of passing through an ASTM standard testing sieve of the larger mesh size. For example, particles having sizes in the range of from 16 to 35 mesh (−16/+35 mesh) means that particles are included in this range which are capable of passing through an ASTM No. 16 U.S.A. standard testing sieve, but incapable of passing through an ASTM No. 35 U.S.A. standard testing sieve.

As used herein, unless specified otherwise, the term “cutting portion” refers to the portion of a parent cutting element (e.g., milled teeth or generally conical-shaped bodies) including any layers applied thereto or inserts that extends beyond the surface of the roller cone cutter. As used herein, unless specified otherwise, the term “base portion” refers to the portion of a parent cutting element or insert that extends beneath the surface of the roller cone cutter and is separate from the cone body.

As used herein, unless specified otherwise, the term “leading” refers to the edge, surface, flank, side, half, or particular region of the cutting portion which leads relative to the direction of cone rotation about the cone axis.

As used herein, unless specified otherwise, the term “trailing” refers to the edge, surface, flank, side, half, or particular region of the cutting portion which trails or follows the leading side relative to the direction of cone rotation about the cone axis. Generally, the trailing side may be disposed opposite or 180° from the leading side.

As used herein, unless specified otherwise, the term “extension height” refers to the axial distance that a cutting portion extends beyond the surface of the roller cone.

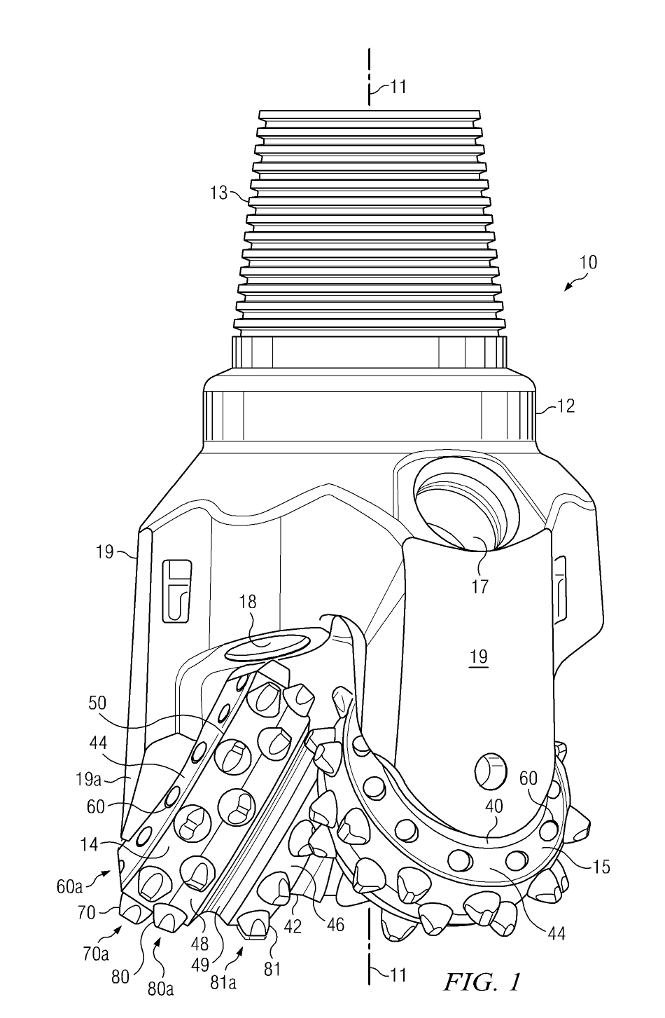

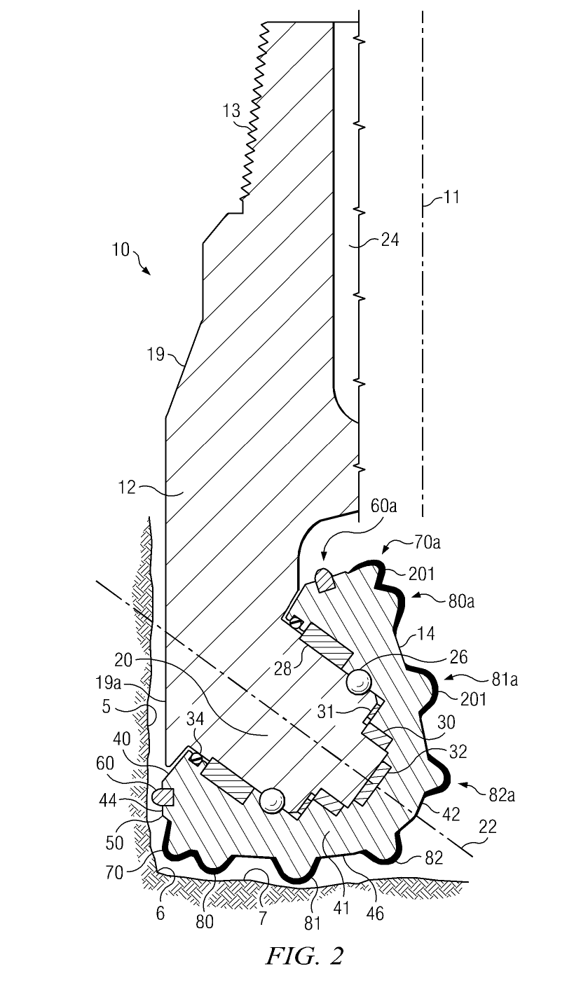

Referring first to FIGS. 1 and 2, an earth-boring roller cone bit 10 according to an embodiment of the present disclosure is shown. Bit 10 includes a central axis 11 and a bit body 12 having a threaded section 13 on its upper end for securing the bit to the drill string (not shown). Bit 10 has a predetermined gage diameter as defined by three roller cone cutters 14, 15, 16 (two of which are shown in FIG. 1) rotatably mounted on bearing journals (shafts or pins) that depend from the bit body 12. Bit body 12 is composed of three sections or legs 19 (two of which are shown in FIG. 1) that are welded together to form bit body 12. Bit 10 further includes a plurality of nozzles 18 that are provided for directing drilling fluid toward the bottom of the borehole and around roller cone cutters 14-16, and lubricant reservoirs 17 that supply lubricant to the bearings of each of the cutters. Bit legs 19 include a shirttail portion 19a that serves to protect cone bearings and seals from damage caused by cuttings and debris entering between the leg 19 and its respective roller cone.

Referring now to FIG. 2, in conjunction with FIG. 1, each roller cone cutter 14-16 is rotatably mounted on a pin or journal 20, with an axis of rotation 22 oriented generally downwardly and inwardly toward the center of the bit. Drilling fluid is pumped from the surface through fluid passage 24 where it is circulated through an internal passageway (not shown) to nozzles 18 (FIG. 1). Each roller cone 14-16 is typically secured on pin or journal 20 by locking balls 26. In the embodiment shown, radial and axial thrust are absorbed by roller bearings 28, 30, thrust washer 31 and thrust plug 32; however, the present disclosure is not limited to use in a roller bearing bit but may equally be applied in a friction bearing bit, where roller cones 14-16 would be mounted on journals 20 without roller bearings 28, 30. In both roller bearing and friction bearing bits, lubricant may be supplied from reservoir 17 to the bearings by an apparatus that is omitted from the figures for the sake of clarity. The lubricant is sealed and drilling fluid excluded by an annular seal 34. The borehole created by bit 10 includes sidewall 5, corner portion 6 and bottom 7, best shown in FIG. 2.

Referring still to FIGS. 1 and 2, each roller cone cutter 14-16 includes a back face 40 and nose portion 42. Further, each roller cone 14-16 includes a generally frustoconical surface 44 that is adapted to retain inserts 60 that scrape or ream the sidewalls of the borehole as roller cones 14-16 rotate about the borehole bottom. Frustoconical surface 44 will be referred to herein as the “heel” surface of roller cones 14-16, it being understood however, that the same surface may sometimes be referred to by others skilled in the art as the “gage” surface of a roller cone cutter.

Extending between the heel surface 44 and nose 42 is a generally conical cone body surface 46 having a plurality of parent cutting elements which are generally conical in shape 70, 80, 81, 82. The parent elements 70, 80, 81, 82 have a layer of wear resistant material 201 applied by a thermal spray process and subsequently subjected to conditions sufficient to sinter the wear resistant material (i.e., sintered) to form wear resistant cutting elements that gouge or crush the borehole corner 6 and bottom 7 as the roller cones 14-16 rotate about the borehole. Conical surface 46 typically includes a plurality of generally frustoconical segments 48 generally referred to as “lands” which are employed to support the cutting elements 80-82 as described in more detail below. Grooves 49 are formed in cone surface 46 between adjacent lands 48. Frustoconical heel surface 44 and conical surface 46 converge in a circumferential edge or shoulder 50. Although referred to herein as an “edge” or “shoulder,” it should be understood that shoulder 50 may be contoured, such as a radius, to various degrees such that shoulder 50 will define a contoured zone of convergence between frustoconical heel surface 44 and the conical surface 46.

In the embodiment shown in FIGS. 1 and 2, each roller cone cutter 14-16 includes a plurality of wear resistant cutting elements 70, 80, 81, 82, as described above, and a plurality of heel row inserts 60. Exemplary roller cone 14, illustrated in FIG. 2, includes a plurality of heel row inserts 60 that are secured in a circumferential heel row 60a in the frustoconical heel surface 44. Roller cone 14 further includes a circumferential gage row 70a of gage wear resistant cutting elements 70 comprising a layer of wear resistant material 201 applied by a thermal spray process and sintered to parent cutting elements which are integrally formed with the cone body 41 and located along or near the circumferential shoulder 50. Roller cone 14 further includes a plurality of inner row wear resistant cutting elements 80-82 which also comprise a layer of wear resistant material 201 applied by a thermal spray process and sintered to parent cutting elements which are integrally formed with the cone body 41 and arranged in spaced-apart inner rows 80a, 81a, 82a, respectively. Bit 10 may include one or more additional inner rows containing wear resistant cutting elements in addition to inner rows 80a, 81a, 82a. Heel inserts 60 generally function to scrape or ream the borehole sidewall 5 to maintain the borehole at full gage, to prevent erosion and abrasion of heel surface 44, and to protect the shirttail portion 19a of bit leg 19. Cutting elements 80-82 of inner rows 80a-82a are employed primarily to gouge or crush and remove formation material from the borehole bottom 7. Inner rows 80a-82a of roller cone 14 are arranged and spaced on roller cone 14 so as not to interfere with the inner rows on each of the other roller cone cutters 15, 16. Gage cutter elements 70 cut the corner of the borehole and, as such, perform sidewall cutting and bottomhole cutting.

Inserts 60 each include a base portion and a cutting portion. The base portion of each insert is disposed within a mating socket drilled or otherwise formed in the cone steel of roller cone cutters 14-16. Each insert 60 may be secured within the mating socket by any suitable means including without limitation an interference fit, brazing, or combinations thereof. The cutting portion of the insert 60 extends from the base portion of the insert and includes a cutting surface for scraping or reaming formation material. The cutting portion of the heel row insert 60 is depicted as a dome-shaped surface, however, a person of ordinary skill would appreciate that other configurations may also be used. In particular, the heel row may contain wear resistant cutting elements similar to those utilized in the gage and inner rows but having a lower extension height. The present embodiment will be understood with reference to one such roller cone 14, roller cones 15, 16 being similarly, although not necessarily identically, configured. Such a roller cone cutter as shown in FIG. 2 is merely one example of various arrangements that may be made according to the present disclosure. For example, although not depicted in FIG. 2, it is understood that the wear resistant material may be applied to only a portion of the parent cutting element (e.g., the leading edge or surface). Additionally, although not depicted in FIG. 2, it is understood that the wear resistant material may also be applied to the exterior surface of the cone body.

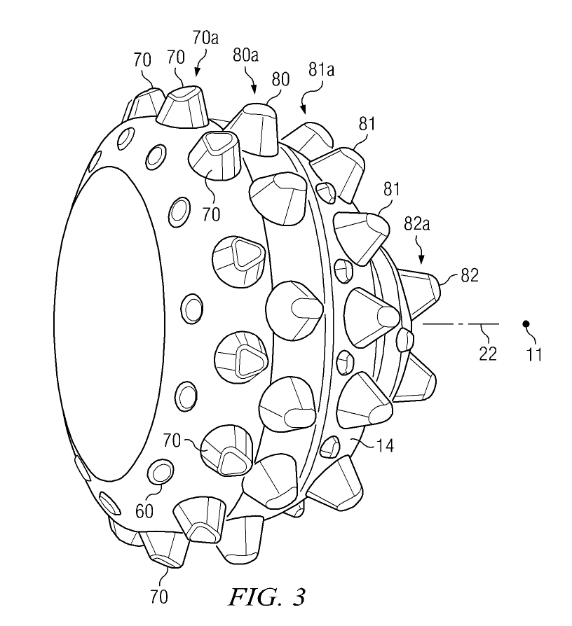

An enlarged view of a roller cone 14 is shown in FIG. 3. As shown, the roller cone cutter 14 includes a gage row 70a having a plurality of wear resistant cutting elements 70 circumferentially arranged about the cone, and an inner row 80a adjacent thereto. Inner row 80a is positioned axially inward of gage row 70a. Cutting elements 70, in this embodiment, are oriented so as to engage the corner portion of the borehole while wear resistant cutting elements 80 are oriented so as to engage the bottom of the borehole. Roller cone 14 additionally has inner rows 81a and 82a circumferentially arranged about the cone. Inner row 81a is positioned axially inward of inner row 80a and inner row 82a is positioned axially inward of inner row 81a (i.e., closer to the nose of the roller cone).

The gage row, one or more inner rows, and/or heel row may comprise wear resistant cutting elements comprising a layer of wear resistant material applied by a thermal spray process and sintered to a parent cutting element. In some embodiments, one or more of the inner rows may comprise wear resistant cutting elements comprising a layer of wear resistant material applied by a thermal spray process and sintered to a parent cutting element while the gage row and optionally the heel row comprise inserts, such as TCIs, that are secured into the cone body. In some embodiments, the gage row may comprise wear resistant cutting elements comprising a layer of wear resistant material applied by a thermal spray process and sintered to a parent cutting element while the inner rows and optionally the heel row comprise inserts, such as TCIs, that are secured into the cone body. Such inserts may be formed by subjecting a metal carbide and a binder to conditions sufficient to sinter the materials (sintered inserts). The metal carbide may be selected from carbides of W, Ti, Mo, Nb, V, Hf, Ta and Cr. The binder may be selected from Group VIII elements of the Periodic Table (CAS version in the CRC Handbook of Chemistry and Physics), in particular cobalt, nickel, iron, mixtures and alloys thereof. Preferably, the inserts comprise a metal carbide of tungsten carbide and a binder of cobalt. The inserts may be formed of a sintered mixture of metal carbide and binder (e.g., a semi-round top heel insert or TCI) and optionally may also include a layer of ultra hard material such as polycrystalline diamond (e.g., a pre-flat heel cutter or a diamond enhanced insert).

Such a roller cone drill bit as shown in FIG. 1 is merely one example of various arrangements that may be used in a drill bit which is made according to the present disclosure. For example, the roller cone drill bit illustrated in FIG. 1 has three roller cones. However, one, two and four roller cone drill bits are also known in the art. Therefore, the number of such roller cones on a drill bit is not intended to be a limitation on the scope of the present disclosure.

The body of the roller cone cutter may be formed from any suitable material for forming a roller cone cutter. The type of material may be chosen based on the end use application such as oilfield, mining, water-wells, etc. Suitable materials may include steel alloys, composite materials, and other metal-based alloys (e.g., nickel-based alloys and cobalt-based alloys). Suitable steel alloys may include low alloy steels, high alloy steels and carbon steels. Low alloy steels, as used herein, contain at most 8% by weight (% w), based on the total weight of the steel, of alloying elements. Such alloying elements may include one or more of manganese, silicon, aluminum, nickel, chromium, cobalt, molybdenum, vanadium, tungsten, titanium, niobium, zirconium, nitrogen, sulfur, copper, boron, lead, tellurium, and selenium. High alloy steels, as used herein, contain greater than 8% w of alloying elements and include stainless steels and tool steels. Carbon steel, as used herein, is a steel whose properties are determined primarily by the amount of carbon present. Apart from iron and carbon, manganese up to 1.5 % w may be present as well as residual amounts of alloying elements such as nickel, chromium, molybdenum, etc. It is when one or more alloying elements are added in sufficient amount that it is classed as an alloy steel. Composite materials, as used herein, may be formed using an infiltration process (as distinguished from a sintering process which uses greater temperatures and/or pressures) and may comprise a metal carbide, nitride, and/or carbonitride and a metal infiltrant. The metal infiltrant may be any metal or metal alloy suitable for infiltrating and forming a composite material. Such metal infiltrants may include Group VIII elements of the Periodic Table, in particular nickel, cobalt, iron, mixtures and alloys thereof. Such metal infiltrants may also include Group IB elements of the Periodic Table (CAS version in the CRC Handbook of Chemistry and Physics), in particular copper and alloys thereof. The roller cones may be formed by any of a variety of methods. The methods may include forging, machining, casting, molding, injection-molding, weld-forming, laser-forming, and combinations thereof.

The roller cone cutter includes a plurality of parent cutting elements (or structures). The parent cutting elements may be milled teeth or generally conical-shaped bodies or projections (different from milled teeth). As used herein, the term “milled teeth” or “milled tooth” is meant to include parent cutting elements that are generally triangular in a cross-section taken in a radial plane of the cone. The milled teeth or generally conical-shaped bodies or projections are arranged such that there is a leading edge or surface which leads the element relative to the direction of motion of the cone and a trailing edge or surface. The generally conical-shaped bodies may have a continuously contoured cutting portion. For example, the generally conical-shaped bodies may have a continuously contoured leading side having a radius of curvature greater than 0.050 inches (1.27 mm). The generally conical-shaped bodies may have angular portions. The generally conical-shaped bodies may have a shape selected from ballistic, conical, dome-shaped, hemispherical, semi-round, symmetrical, asymmetrical, chisel-shaped, inclined chisel-shaped, symmetrically chamfered, asymmetrically chamfered, and combinations thereof. The parent cutting elements may be formed of any suitable materials. Suitable materials include those described above for the roller cone body (e.g., non-sintered cutting elements/inserts) and are not meant to include inserts formed by sintering a metal carbide and a binder. The type of material may be chosen based on the end use application such as oilfield, mining, water-wells, etc.

The parent cutting elements may be integrally formed with the body of the roller cone. In other words, the cone body and the parent cutting elements may be a single piece or unitary structure. Alternatively, the parent elements may be formed separately from the cone body and may include a base portion and a cutting portion. The base portion of the parent elements may be secured within mating sockets (or apertures) by interference press fit, welding, brazing or the like. The parent cutting elements may be formed of the same material as the body of the roller cone cutter or may be formed of a different material to provide one or more different properties between the parent cutting element and the cone body. The one or more properties may include hardness and toughness. For example, the parent cutting elements may be formed of a different material (e.g., different steel or composite material) from the cone body which has a greater hardness as compared to the material of the cone body.

After the roller cone cutter is formed, a wear resistant material is applied by a thermal spray process to at least a portion (e.g., the leading surface or flank) of at least one of the parent cutting elements on the surface of the cone. Suitably, the wear resistant material may be applied to the entire surface of the parent element. Optionally, the wear resistant material may also be applied to the surface of the cone body. There are a variety of thermal spray processes which are known in the art and all the various processes involve high velocity ballistic application of particles onto a target surface, typically by feeding a powder into a gaseous effluent of a combustion chamber into which fuel in the form of hydrogen or hydrocarbons and oxygen are fed. The powder is heated to very high temperatures and then emitted from the combustion chamber at very high velocities onto the target surface where it impacts, spreading itself onto the surface. Suitably, the thermal spray process may be selected from a detonation gun process (D-gun), a super detonation gun process (Super D-gun), a high velocity oxygen fuel (HVOF) process, a high velocity air fuel (HVAF) process, a plasma spray process and a flame spray process. Preferably, the thermal spray process may be selected from detonation gun, super detonation gun and high velocity oxygen fuel processes. Such detonation gun processes are described in U.S. Pat. No. 4,826,734 and U.S. Pat. No. 5,075,129, which processes are incorporated herein by reference in their entirety. Such super detonation gun processes are described in U.S. Pat. No. 5,535,838, which processes are incorporated herein by reference in their entirety. Such high velocity oxygen fuel processes are described in further detail below. More preferably, the thermal spray process may include a high velocity oxygen fuel process which may utilize a gaseous or liquid fuel, in particular a liquid fuel. Equipment for use in a HVOF process is commercially available from Praxair Surface Technologies, Inc. and Sulzer Metco, Inc. Examples of gas-fueled HVOF equipment are the air- or water-cooled DIAMOND JET® series by Sulzer Metco, Inc. and examples of liquid-fueled HVOF equipment are the JP™ series by Praxair Surface Technologies, Inc. and the WOKAJET™ series by Sulzer Metco, Inc.

In a HVOF spray process, a spray axis of an apparatus for the thermal spray process may be preferably aligned perpendicular to a surface of the roller cone cutter. The nozzle of the apparatus then emits detonation waves of hot gases at very high velocities, for example 700 to 3300 ft/sec (200 to 1000 meters/sec), the detonation waves entraining a powder of the wear resistant material. The fuel may be hydrogen or a hydrocarbon and may be provided in a gaseous or liquid form. A fluid substance such as liquid carbon dioxide may be used to cool the surface of the roller cone during the thermal spray process, to prevent the surface of the roller cone from being heated above 400° F. (approximately 200° C.). The thermal spray process may be repeated a number of times until a desired thickness is reached.

After applying the wear resistant material by a thermal spray process, the roller cone cutter may be subjected to a sintering process. The sintering process can provide for improved bonding (and thus improved performance) since a substantial amount of metallurgical bonding occurs between the particles of the wear resistant material and between particles of the wear resistant material and the surface onto which the material is applied (e.g., the parent cutting elements). Without sintering, mechanical bonding is the primary bonding mechanism. The sintered wear resistant material may have a hardness of at least 80 Rockwell “A” hardness (Ra), in particular at least 85 Ra. The thickness of the sintered layer of wear resistant material may have a thickness of at least 0.125 mm (0.005 inches), as described herein, for example in the range of from 0.125 to 25 mm (0.005 to 1 inch), from 0.25 to 13 mm (0.01 to 0.5 inches), from 0.35 to 10 mm (0.015 to 0.4 inches), or from 0.5 to 5 mm (0.02 to 0.2 inches). The thickness of the wear resistant layer may be chosen based on the particular drilling application.

The sintering process uses temperature and pressure conditions sufficient to consolidate and bond the wear resistant material to the parent cutting elements. Sintering processes may include vacuum sintering, inert gas sintering, microwave sintering, induction furnace sintering, or hot isostatic pressing (HIP). The temperature of the sintering process may range from 800° C. to 1600° C. or from 900° C. to 1400° C., for example 950° C., 1000° C., 1050° C., 1075° C., 1100° C., 1125° C., 1150° C., 1175° C., 1200° C., 1225° C., 1250° C., or 1300° C. The sintering process may be conducted using any suitable pressure depending on the sintering process utilized. For example, the pressures may range from 100 mPa (millipascals) to 11 MPa (megapascals), such as 101 kPa (kilopascals), 500 kPa, 700 kPa, 1000 kPa, 1400 kPa, 2 MPa, 2.5 MPa, 3 MPa, 3.5 MPa, 4 MPa, 4.5 MPa, 5 MPa, 5.5 MPa, 6 MPa, 7 MPa, 8 MPa, 9 MPa, or 10 MPa. In one or more embodiments, the pressure may range from 700 kPa to 11 MPa or from 1400 kPa to 5.5 MPa, for example 750 kPa, 1000 kPa, 1450 kPa, 2 MPa, 2.5 MPa, 3 MPa, 3.5 MPa, 4 MPa, 4.5 MPa, or 5 MPa. The duration of the sintering process at the specified pressures and temperatures may be at least 30 seconds or at least 1 minute. The duration of the sintering process at the specified pressures and temperatures may be at most 100 hours or at most 75 hours. The duration of the sintering process at the specified pressures and temperatures may be in the range of from 30 seconds (0.0083 hours) to 50 hours (180000 seconds) or from 1 minute (0.0167 hours) to 24 hours (1440 minutes), for example 5 minutes (0.083 hours), 15 minutes (0.25 hours), 30 minutes (0.5 hours), 45 minutes (0.75 hours), 1 hour (60 minutes), 1.25 hours (75 minutes), 1.5 hours (90 minutes), 1.75 hours (105 minutes), 2 hours (120 minutes), 4 hours (240 minutes), 8 hours (480 minutes), 12 hours (720 minutes), 16 hours (960 minutes), or 20 hours (1200 minutes). The sintering process may be conducted in a one or more steps or stages. When using multiple steps/stages, different parameters may be used between different steps/stages (e.g., different pressures, temperatures, or duration). One skilled in the art would also appreciate that the pressure, temperature and duration of the sintering process may vary depending on the sintering process employed.

The wear resistant material applied by the thermal spray process may comprise hard particles and a binder. The hard particles may be selected from carbides, nitrides, and carbonitrides of tungsten (W), titanium (Ti), molybdenum (Mo), niobium (Nb), vanadium (V), hafnium (Hf), tantalum (Ta), and chromium (Cr). Suitably, the hard particles may be selected from carbides of W, Ti, Mo, Nb, V, Hf, Ta and Cr. The hard particles may further comprise boronitrides, diamond, and refractory metals such as tungsten (W), molybdenum (Mo), niobium (Nb), tantalum (Ta), and rhenium (Re). The binder may be selected from Group VIII elements of the Periodic Table, in particular cobalt, nickel, iron, mixtures and alloys thereof. Examples of binder compositions include cobalt and chromium; cobalt and iron; nickel and iron; and a combination of nickel, molybdenum, chromium, iron, and cobalt. Preferably, the hard particles comprise tungsten carbide and the binder comprises cobalt. The tungsten carbide may comprise mono-tungsten carbide, although other tungsten carbides such as cemented and cast may be used. The tungsten carbide particles may have an average particle (or grain) size in the range of from 0.5 to 44 microns (micrometers), for example from 1 to 20 microns, from 1 to 10 microns, or 2 to 6 microns. The binder may be present in an amount of at least 3% w, based on the total weight of the wear resistant material pre-application, in particular in the range of from 10 to 20% w, for example 12% w, 15% w, 17% w, on the same basis. The hard particles may be present in an amount in the range of from 80 to 95% w, based on the total weight of the wear resistant material pre-application The sintered wear resistant material may have a porosity less than 0.8% by volume. With such low porosity, the actual density approaches the theoretical density. The sintered wear resistant material as applied by the thermal spray process has improved properties, such as improved bonding, as discussed above. These improved properties can lead to an improvement in bit performance, in particular bit durability.

In an exemplary embodiment, parent cutting elements in different areas of the roller cone may be provided with wear resistant material layers having different properties. One or more properties may differ and may be selected from hardness, thickness, hard particle content, hard particle average grain size, toughness, composition, binder content, density, porosity, elastic modulus, microstructure, abrasion resistance, and erosion resistance. In particular, the binder content and/or the hard particle average grain (or particle) size may differ. As used herein, the terms “different” or “differ” are not meant to include typical variations in manufacturing. For example, a first plurality of parent cutting elements may be arranged in a circumferential gage row and a second plurality of parent cutting elements may be arranged in one or more circumferential inner rows. The first plurality of parent elements may be provided with a layer of wear resistant material applied by a thermal spray process and subsequently sintered. The second plurality of parent elements may also be provided with a layer of wear material applied by a thermal spray process and subsequently sintered. The layer of wear resistant material on the gage row parent cutting elements may differ with respect to one or more properties from the layer of wear resistant material on the inner row parent cutting elements.

As used herein, a “layer” is meant to include a region containing wear resistant material with the same properties which includes typical variations in manufacturing. It is understood that a thermal spray process may be repeated several times using the same wear resistant material to obtain the desired thickness of a particular layer.

Bits incorporating roller cones prepared according to this embodiment are believed to provide an improved drill bit, in particular, a more durable and cost effective bit. A more cost effective bit may be provided as the wear resistant material is applied to parent cutting elements using a thermal spray process and subsequently sintered. This provides for a reduction in manufacturing costs, for example the usage of tungsten carbide inserts (TCI) can be decreased, the amount of labor can be reduced and the manufacturing process can be simplified. In some embodiments, when using a generally conical-shaped body integrally formed with the cone body as a parent cutting element, a larger journal, bearing, and/or seal assembly may be used since a base portion of an insert does not have to be accommodated within the cone body. This can extend the bit life due to reduced breakage, improved bearing life, and/or improved seal life.

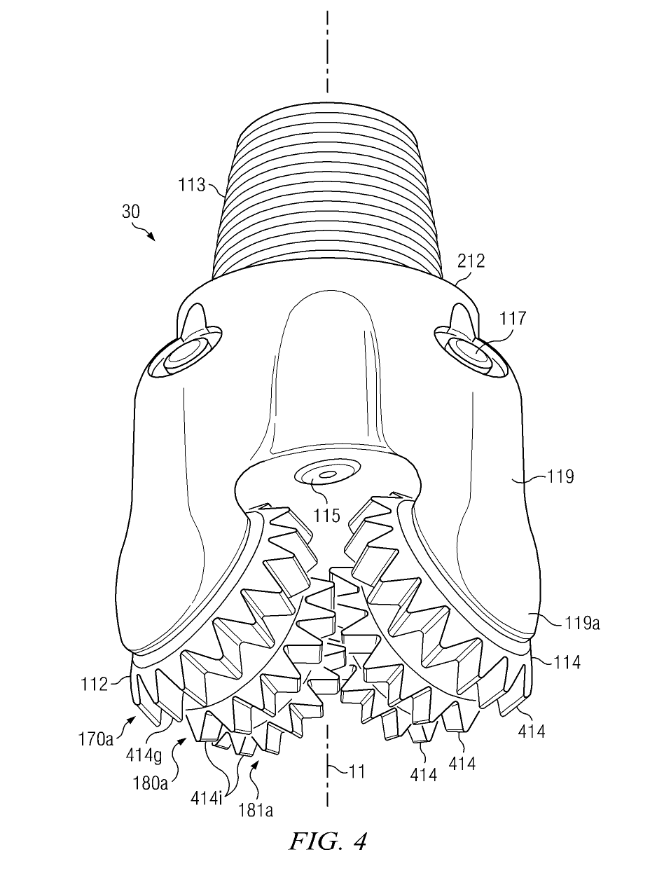

In one or more embodiments, a roller cone drill bit has a plurality of parent cutting elements having at least two layers, an outer layer and a first intermediate layer, applied on at least a portion (e.g., a leading surface or flank) of at least one of the parent cutting elements. At least one of the at least two layers being applied utilizing a thermal spray process and comprising a wear resistant material, as discussed above. Suitably, the layers may be applied to the entire surface of the parent cutting element. Optionally, one or more of the layers may also be applied to the surface of the cone body. Suitably, the parent cutting element may have three, four, five, six or more layers applied thereto. Referring to FIGS. 4, 5 and 6, a milled tooth roller cone bit 30 according to an embodiment of the present disclosure is shown. The milled tooth roller cone drill bit 30 includes a central axis 11 and a steel bit body 212 having a threaded coupling (“pin”) 113 at one end for connection to a conventional drill string (not shown). At the opposite end of the drill bit body 212 there are three roller cones 112, 114, 116 for drilling earthen formations to form an oil well or the like (“wellbore”). Bit 30 has a predetermined gage diameter as defined by three roller cone cutters 112, 114, 116 (two of which are shown in FIG. 4) rotatably mounted on bearing journals (shafts or pins) (not shown) that depend from the bit body 212. Bit body 212 is composed of three sections or legs 119 (two of which are shown in FIG. 4) that are welded together to form the bit body. Bit 30 further includes a plurality of nozzles 115 that are provided for directing drilling fluid toward the bottom of the borehole and around roller cone cutters 112, 114, 116, and lubricant reservoirs 117 that supply lubricant to the bearings of each of the cones. Bit legs 119 include a shirttail portion 119a that serves to protect cone bearings and seals from damage caused by cuttings and debris entering between the leg 119 and its respective roller cone.

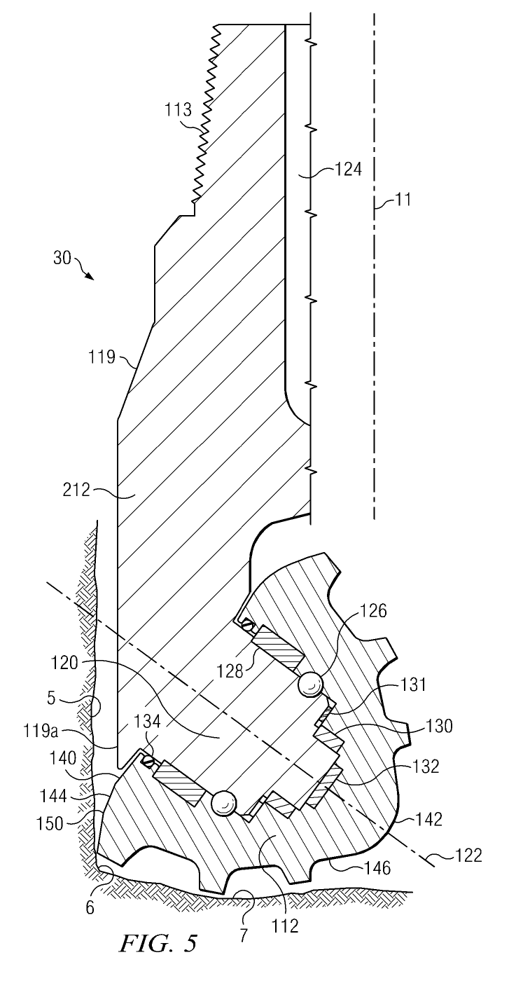

Referring now to FIG. 5, in conjunction with FIG. 4, each roller cone cutter 112, 114, 116 is rotatably mounted on a pin or journal 120, with an axis of rotation 122 oriented generally downwardly and inwardly toward the center of the bit. Drilling fluid is pumped from the surface through fluid passage 124 where it is circulated through an internal passageway (not shown) to nozzles 115 (FIG. 4). Each roller cone 112, 114, 116 is typically secured on pin or journal 120 by locking balls 126. In the embodiment shown, radial and axial thrust are absorbed by roller bearings 128, 130, thrust washer 131 and thrust plug 132; however, the present disclosure is not limited to use in a roller bearing bit but may be equally applied in a friction bearing bit, where roller cones 112, 114, 116 would be mounted on journals 120 without roller bearings 128, 130. In both roller bearing and friction bearing bits, lubricant may be supplied from reservoir 117 to the bearings by an apparatus that is omitted from the figures for the sake of clarity. The lubricant is sealed and drilling fluid excluded by an annular seal 134. The borehole created by bit 30 includes sidewall 5, corner portion 6 and bottom 7, best shown in FIG. 5.

Referring still to FIGS. 4 and 5, each roller cone cutter 112, 114, 116 includes a back face 140 portion and a nose portion 142. Further each roller cone 112, 114, 116 includes a generally frustoconical surface 144 which will be referred to herein as the “heel” surface of roller cones 112, 114, 116. Although not shown in FIGS. 4 and 5, the heel surface of roller cones 112, 114, 116 may contain one or more heel row inserts, as discussed above, secured within mating sockets (or apertures).

Extending between the heel surface 144 and nose 142 is a generally conical surface 146 having a plurality of teeth integrally formed with the surface of the cone. Frustoconical heel surface 144 and conical surface 146 converge in a circumferential edge or shoulder 150. Although referred to herein as an “edge” or “shoulder,” it should be understood that shoulder 150 may be contoured, such as a radius, to various degrees such that shoulder 150 will define a contoured zone of convergence between frustoconical heel surface 144 and conical surface 146.

Referring again to FIG. 4, the roller cones 112, 114, 116 are shaped and mounted so that as they roll, radially-extending steel teeth 414 integrally formed from the steel of the roller cones 112, 114, 116 gouge, chip, crush, abrade, and/or erode the earthen formations (not shown) at the bottom of the wellbore. The teeth 414G in the circumferential row around the heel of the cone 112 are referred to as the “gage row” teeth 414G in the “gage row” 170a. They engage the corner portion of the hole being drilled near its perimeter or “gage”. The teeth 414i in the circumferential inner rows between the gage row and the nose of the cone are referred to as the “inner row” teeth 414i in the inner rows 180a and 181a. They engage the bottom of the borehole being drilled. Inner rows 180a and 181a are arranged and spaced on roller cone 112 so as not to interfere with the inner rows on each of the other roller cone cutters 114, 116. Fluid nozzles 115 direct drilling fluid (“mud”) into the hole to carry away the particles of formation created by the drilling.

Such a roller cone drill bit as shown in FIG. 4 is merely one example of various arrangements that may be used in a drill bit which is made according to the present disclosure. For example, the roller cone drill bit illustrated in FIG. 4 has three roller cones. However, one, two and four roller cone drill bits are also known in the art. The arrangement of the teeth 414 on the cones 112, 114 shown in FIG. 4 is just one of many possible variations. In fact, it is typical that the teeth on the three cones on a rock bit differ from each other so that different portions of the hole are engaged by each of the three roller cones so that collectively the entire bottom of the hole is drilled. A broad variety of tooth and cone geometries are known and do not form a specific part of this disclosure, nor should the present disclosure be limited in scope by any such arrangement.

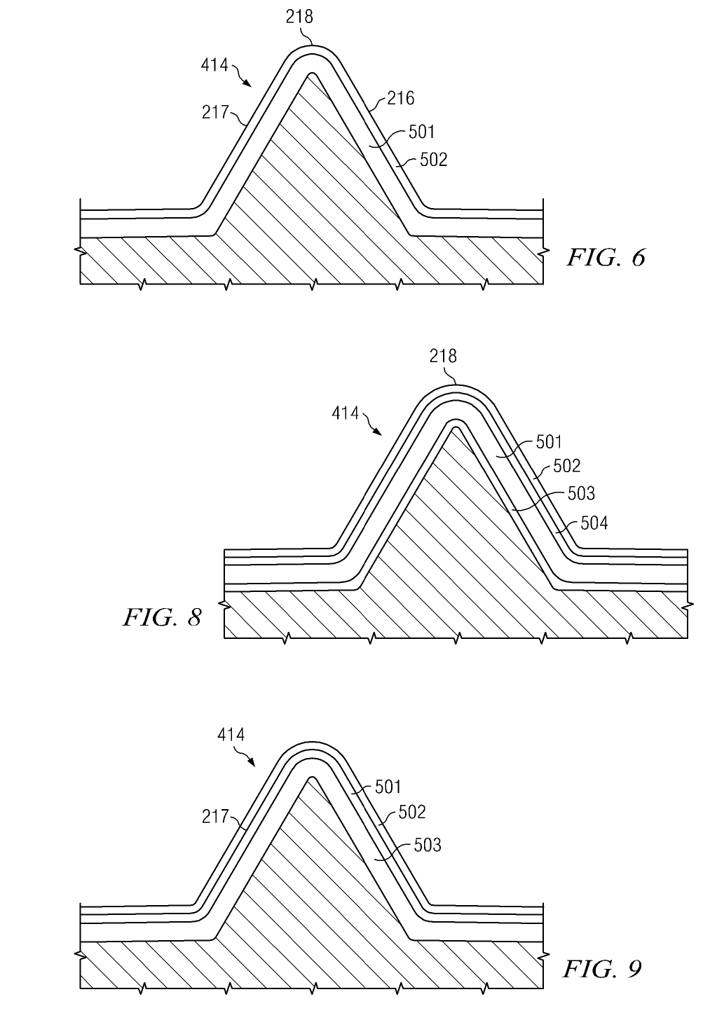

The example teeth on the roller cones shown in FIGS. 4 and 5 are generally triangular in a cross-section taken in a radial plane of the cone. Referring to FIG. 6, such a tooth 414 has a leading flank 216 and a trailing flank 217 meeting in an elongated crest 218. The flanks and crest of the tooth 414 are covered with two layers 502 and 501. Alternatively, only a portion (e.g., the leading flank and/or crest) of each such tooth 414 may be covered with both layers. Layer 502 is the outermost layer and layer 501 is a first intermediate layer positioned between the surface of the tooth and the outer layer 502. It has been found that it can be particularly advantageous to provide at least two layers to a parent cutting element at least one of which is applied utilizing a thermal spray process and comprises a wear resistant material. Such roller cones can provide for a more durable drill bit.

The material used for forming the body of the roller cone cutter has been described above. At least one layer applied to the parent cutting element is applied using a thermal spray process. Examples of thermal spray processes include those described hereinbefore. The thermally sprayed layer comprises a wear resistant material. The wear resistant material comprises hard particles and a binder, as discussed above. The at least two layers may or may not be subsequently sintered after application on the roller cone. In one or more embodiments, the layer of wear resistant material may be sintered and have a hardness of at least 80 Rockwell “A” hardness (Ra), in particular at least 85 Ra. The sintered layer of wear resistant material may have a porosity which is less than 0.8% by volume. With such low porosity, the actual density approaches the theoretical density. Layers of wear resistant material may have a thickness of at least 0.125 mm (0.005 inches), in particular in the range of from 0.125 to 7.6 mm (0.005 to 0.3 inches), from 0.2 to 5 mm (0.008 to 0.2 inches), from 0.25 to 2.5 mm (0.01 to 0.1 inches), or from 0.4 to 1.25 mm (0.015 to 0.05 inches). The desirable thickness depends on the end-use application as well as the number of layers applied to the parent cutting element.

In one or more embodiments, the total thickness of the one or more layers applied (including all wear resistant layers, hardfacing layers and buffer layers combined) may be at least 0.125 mm (0.005 inches), at least 0.35 mm (about 0.015 inches), at least 0.75 mm (about 0.03 inches), at least 1.25 mm (about 0.05 inches), at least 2.5 mm (about 0.1 inches), at least 5 mm (about 0.2 inches), or at least 7.5 mm (about 0.3 inches). The total thickness of all the layers applied may be at most 40 mm (about 1.5 inches), at most 30 mm (about 1.25 inches) or at most 25 mm (about 1 inch). For example the total thickness of all the layers applied may be 0.5 mm (about 0.02 inches), 1 mm (about 0.04 inches), 1.5 mm (about 0.06 inches), 2 mm (about 0.08 inches), 5.5 mm (about 0.22 inches), 10 mm (about 0.4 inches), 12 mm (about 0.5 inches), 15 mm (about 0.6 inches), or 20 mm (about 0.8 inches). The desirable total thickness may depend on the particular end-use application.

In an exemplary embodiment, the outer layer may comprise a first wear resistant material applied by a thermal spray process and the first intermediate layer may also be applied to the parent cutting element using a thermal spray process. The first intermediate layer may comprise a second wear resistant material. The second wear resistant material comprises hard particles and a binder, as discussed above. The second wear resistant material differs with respect to one or more properties from the wear resistant material in the outer layer. The one or more properties may be selected from hardness, hard particle content, hard particle average grain size, toughness, composition, binder content, density, porosity, elastic modulus, microstructure, abrasion resistance, and erosion resistance. In particular, the binder content and/or the hard particle average grain (or particle) size may differ. The difference in properties may provide a gradient between the surface of the parent cutting element and the outer layer. Alternatively, the difference in properties may provide for an interruption in properties between the surface of the parent cutting element and the outer layer. In one or more embodiments, three or more wear resistant layers applied by a thermal spray process may be used.

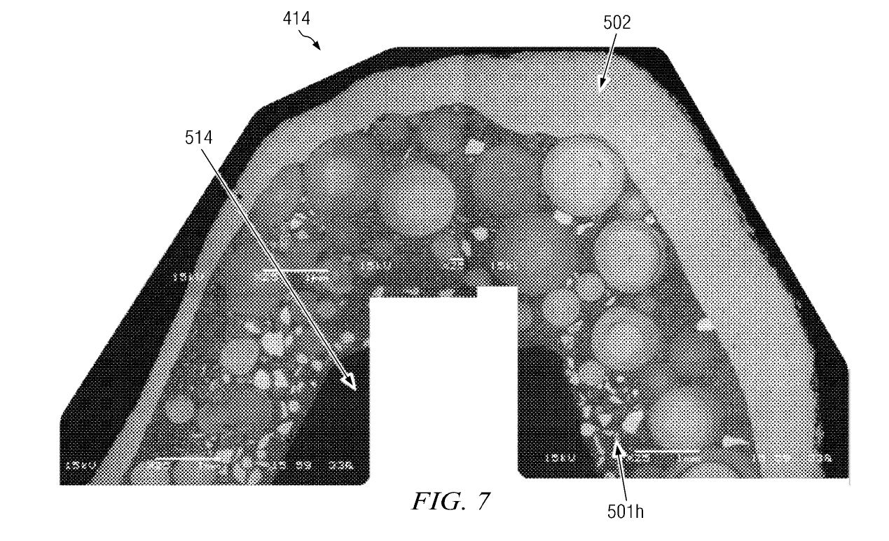

In an exemplary embodiment, as depicted in FIG. 7, the outer layer 502 may comprise a wear resistant material applied by a thermal spray process and the first intermediate layer 501h may comprise a hardfacing composition applied to the milled tooth (i.e., parent cutting element) using welding processes known in the art. Such welding processes may be selected from oxyacetylene welding, plasma transferred arc, atomic hydrogen welding, tungsten inert gas welding, and gas tungsten arc welding. Layers of hardfacing composition may have a thickness of at least 0.5 mm (0.02 inches), in particular in the range of from 1 to 5 mm (0.04 to 0.2 inches). Alternatively, the first intermediate layer may comprise a wear resistant material applied by a thermal spray process and the outer layer may comprise a hardfacing composition applied to the parent cutting element using a welding process. In one or more embodiments, three or more layers may be used.

As shown in FIG. 7, a milled tooth 414 includes a first intermediate layer 501h and an outer layer 502 applied to parent cutting element 514. The first intermediate layer 501h comprises a hardfacing composition and the outer layer 502 comprises a wear resistant material. The thickness of the hardfacing layer (i.e., the first intermediate layer 501h) is greater than the thickness of the wear resistant layer (i.e., the outer layer 502). The hardfacing layer comprises a carbide phase containing a primary carbide of spherical cemented tungsten carbide-cobalt (sometimes referred to as sintered tungsten carbide-cobalt), a secondary carbide of crushed cast tungsten carbide, and a mono-tungsten carbide; and an iron-based matrix. The outer layer 502 comprises hard particles of mono-tungsten carbide and a binder of cobalt. The outer layer of wear resistant material exhibits excellent bonding to the first intermediate layer of hardfacing, creates a smoother (i.e., less rough) exterior surface as compared to the hardfacing layer, and provides a beneficial compressive stress to the surface. Use of such a roller cone is believed to lead to an improvement in the performance of the drill bit by increasing ROP and/or extending the bit life due to the improvement in wear resistance and toughness of the surface.

The hardfacing composition may comprise a matrix and a carbide phase which comprises one or more metal carbides. The hardfacing composition contains metal carbides having a greater average particle size than the hard particles in the wear resistant material. As used herein, the term “carbide phase”, is meant to include the materials which typically may be placed within a welding tube or which may be placed upon a welding wire, i.e., the filler. As used herein, the term “matrix” is meant to include the matrix material which includes materials other than those in the carbide phase. The matrix may be any metal or metal alloy. The matrix may be selected from iron, nickel, cobalt, mixtures and alloys thereof. The matrix may be an iron-based alloy. Such iron-based alloys may include, but are not limited to, soft steels. As used herein, the term “soft steel” is meant to include steel materials which have a low carbon content, for example steel having a carbon content of less than 0.15% by weight, based on the total weight of the steel (i.e., mild steel). Examples of mild steel include, but are not limited to, AISI (American Iron and Steel Institute) 1010 (0.1% w carbon), AISI 1008 (0.08% w carbon), and AISI 1006 (0.06% w carbon) grades of steel.

The carbide phase (“filler”) may be present in an amount of 50% to 75% by weight, based on the total weight of the hardfacing composition pre-application, in particular from 55% w to 70% w, on the same basis. Thus, the matrix may be present in an amount of from 25% to 50% by weight, based on the total weight of the hardfacing composition pre-application, in particular from 30% w to 45% w, on the same basis. All percentages given herein are pre-application percentages unless specified to the contrary.

The carbide phase may comprise a deoxidizer. A suitable deoxidizer may include a silicomanganese composition which may be obtained from Chemalloy in Bryn Mawr, Pa. A suitable silicomanganese composition may contain 65% w to 68% w manganese, 15% w to 18% w silicon, a maximum of 2% w carbon, a maximum of 0.05% w sulfur, a maximum of 0.35% w phosphorus, and a balance comprising iron. Suitably, the deoxidizer may be present in a quantity of at most 5% w, based on the total weight of the carbide phase pre-application, for example about 3% w to about 4% w, on the same basis, may be used.

The carbide phase may also comprise a temporary resin binder. A small amount of thermoset resin may be desirable for partially holding the particles in the carbide phase together so that they do not shift during application, e.g., welding. Suitably, the resin binder may be present in a quantity of at most 1% w, based on the total weight of the carbide phase pre-application, for example about 0.5% w, on the same basis is adequate. The term, “deoxidizer”, as used herein, refers generally to deoxidizer with or without the resin. Suitably, the deoxidizer/resin binder will form no more than about 5% w, preferably about 4% w, based on the total weight of the carbide phase.

The carbide phase includes a primary carbide and optionally a secondary carbide. Various hardfacing compositions are disclosed in U.S. Pat. No. 4,836,307, U.S. Pat. No. 5,791,422, U.S. Pat. No. 5,921,330, U.S. Pat. No. 6,659,206, and U.S. Pat. No. 6,782,958. These references are herein incorporated by reference in their entirety.

Suitably, the one or more metal carbides are mechanically bonded to a surface by a metal (“matrix”). Once applied, the carbide particles are in effect suspended in a matrix of metal forming a layer on the surface. The carbide particles give the hardfacing material hardness and wear resistance, while the matrix metal provides fracture toughness to the hardfacing.

Many factors affect the properties of a hardfacing composition in a particular application. These factors include the chemical composition and physical structure (size and shape) of the carbides, the chemical composition and microstructure of the matrix metal or alloy, and the relative proportions of the carbide materials to one another and the matrix metal or alloy.

The primary metal carbide may comprise any suitable metal carbide. The metal carbide may include, but is not limited to, tungsten carbide, chromium carbide, molybdenum carbide, niobium carbide, tantalum carbide, titanium carbide, vanadium carbide, and mixtures thereof, in particular tungsten carbide. The metal carbide may be in the form of crushed particles or spherical particles (i.e., pellets). The term “spherical”, as used herein and throughout the present disclosure, means any particle having a generally spherical shape and may not be true spheres, but lack the corners, sharp edges, and angular projections commonly found in crushed and other non-spherical particles. The term, “crushed”, as used herein in the present disclosure, means any particle having corners, sharp edges and angular projections commonly found in non-spherical particles.

The metal carbide may comprise a cemented carbide comprising a metal carbide and a metal binder. The carbide may include, but is not limited to, tungsten carbide, chromium carbide, molybdenum carbide, niobium carbide, tantalum carbide, titanium carbide, vanadium carbide, and mixtures thereof, in particular tungsten carbide. The metal binder may include Group VIII elements of the Periodic Table, in particular cobalt, nickel, iron, mixtures thereof, and alloys thereof. Preferably, the metal binder comprises cobalt. The cemented carbide may be in the form of crushed particles or spherical particles (i.e., pellets).

Suitably, the primary carbide may be a tungsten carbide. Many different types of tungsten carbides are known based on their different chemical compositions and physical structure. Three types of tungsten carbide suitably used in hardfacing drill bits are cast tungsten carbide, mono-tungsten carbide, and cemented tungsten carbide. These carbides may be in the form of crushed particles or spherical particles (i.e., pellets). The primary carbide may be selected from cast tungsten carbide, mono-tungsten carbide and cemented tungsten carbide.

Tungsten generally forms two carbides, mono-tungsten carbide (VVC) and ditungsten carbide (W₂C). Cast carbide is a eutectic mixture of the WC and W₂C compounds, as such the carbon content in cast carbide is sub-stoichiometric, (i.e., it has less carbon than the mono-tungsten carbide). Cast carbide is typically made by resistance heating tungsten in contact with carbon in a graphite crucible having a hole through which the resultant eutectic mixture drips. The liquid is quenched in a bath of oil and is subsequently comminuted to the desired particle size and shape.

At least a portion of any cast tungsten carbide particles may be present in the form of particles having a core (or inner region) of cast tungsten carbide and a shell (or outer region) of mono-tungsten carbide. Such cast tungsten carbide particles are described in U.S. Patent Publication No. 2007/0079905, which is incorporated by reference in its entirety (see page 1, paragraph 13 through page 3, paragraph 33). Such cast tungsten carbide particles may have a bound carbon content in the range of from 4% w to 6% w, based on the total weight of the particle, in particular from 4.5% w to 5.5% w, more in particular 4.3% w, to 4.8% w, on the same basis. The free carbon content of such cast tungsten carbide particles may be at most 0.1% w, on the same basis. Such cast tungsten carbide particles may be made using a process wherein cast tungsten carbide powder is heated in the presence of a carbon source to a temperature of 1300 to 2000° C., preferably 1400 to 1700° C.

Mono-tungsten carbide is essentially stoichiometric tungsten carbide. One type of mono-tungsten carbide is macro-crystalline tungsten carbide. Macro-crystalline tungsten carbide may be formed using a high temperature thermite process during which ore concentrate is converted directly to mono-tungsten carbide.

Another type of mono-tungsten carbide is carburized tungsten carbide which is typically multicrystalline in form, i.e., composed of tungsten carbide agglomerates. Carburized tungsten carbide may be formed using a carburization process where solid-state diffusion of carbon into tungsten metal occurs to produce mono-tungsten carbide. Typical mono-tungsten carbide contains a minimum of 99.8% by weight of tungsten carbide with a total carbon content in the range of from about 6.08% to about 6.18% by weight, preferably about 6.13% by weight, based on the weight of tungsten carbide.

Cemented tungsten carbide comprises small particles of tungsten carbide (e.g., 1 to 15 microns), in particular mono-tungsten carbide, bonded together with a metal binder such as Group VIII elements of the Periodic Table, in particular cobalt, nickel, iron, mixtures and alloys thereof, preferably cobalt. Cemented tungsten carbide may be produced by mixing an organic wax, mono-tungsten carbide and metal binder; pressing the mixture to form a green compact; sintering the green compact at temperatures near the melting point of the metal binder; and comminuting the resulting sintered compact to form particles of the desired particle size and shape.

At least a portion of any cemented carbide may be in the form of super dense cemented carbide. The term “super dense cemented carbide”, as used herein, includes the class of sintered particles as disclosed in U.S. Patent Publication No. 2003/0000339, the disclosure of which is incorporated herein by reference (page 2, paragraph 19 through page 3, paragraph 47). Such super dense cemented carbide particles are typically of substantially spheroidal shape (i.e., pellets) and have a predominantly closed porosity or are free of pores. The process for producing such particles starts from a powder material with a partially porous internal structure, which is introduced into a furnace and sintered at a temperature at which the material of the metal binder adopts a pasty state while applying pressure to reduce the pore content of the starting material to obtain a final density.

The secondary carbide differs in composition from the primary carbide and may be any suitable metal carbide, as described above. Suitably, the secondary carbide may also be a tungsten carbide. Such secondary carbide may be selected from cast tungsten carbide, mono-tungsten carbide and cemented tungsten carbide. The secondary carbide may be present in a lesser quantity than the primary carbide, measured based on weight.

In an exemplary embodiment, the hardfacing composition may comprise a primary carbide of cemented carbide, preferably cemented tungsten carbide containing a cobalt metal binder, and a secondary carbide of cast tungsten carbide. Preferably, the cemented carbide may be spherical in form. Preferably, the cast carbide may be present in a quantity of at least 10% w, in particular at least 15% w, more in particular at least 22% w, based on the total weight of the carbide phase pre-application. Preferably, the cast carbide comprises particles having sizes in the range of from 30 to 80 mesh (−30/+80 mesh), in particular 40 to 80 mesh (−401+80 mesh), more in particular 40 to 60 mesh (−40/+60 mesh) pre-application. Preferably, the cast tungsten carbide may be present in crushed form. Preferably, the primary carbide may include a first quantity of cemented carbide having particle sizes in the range of from 16 to 25 mesh (−16/+25 mesh), in particular from 16 to 20 mesh (−16/+20 mesh), and/or a second quantity of cemented carbide comprising particles having sizes in the range of from 25 to 40 mesh (−25/+40 mesh), in particular from 30 to 40 mesh (−30/+40 mesh). The hardfacing composition may also comprise mono-tungsten carbide comprising particles having sizes capable of passing through 300 mesh or greater mesh sizes, in particular from 300 to 500 mesh (−300/+500 mesh). In this embodiment, the first quantity of cemented carbide may be present in an amount of at least 10% by weight, based on the total weight of the carbide phase pre-application, in particular in the range of from 20 to 70% by weight, based on the total weight of the carbide phase, more in particular from 20 to 50% w, on the same basis. In this embodiment, the second quantity of cemented carbide may be present in an amount of at least 10% by weight, based on the total weight of the carbide phase, in particular in the range of from 15 to 45% by weight, based on the total weight of the carbide phase pre-application, more in particular from 15 to 35% w, on the same basis. The mono-tungsten carbide may be present in an amount in the range of from 5 to 15% by weight, based on the total weight of the carbide phase, in particular from 8% w to 12% w, on the same basis.

In an exemplary embodiment, the hardfacing composition may comprise a primary carbide of cemented tungsten carbide containing a cobalt metal binder having sizes in the range of from 25 to 60 mesh (−25/+60 mesh), in particular 30 to 40 mesh (−30/+40 mesh) pre-application. The secondary carbide of cast tungsten carbide preferably has particles having sizes in the range of from 80 to 325 mesh (−80/+325 mesh), in particular from 100 to 200 mesh (−100/+200 mesh) pre-application. Preferably, the cast tungsten carbide may be present in crushed form. The hardfacing composition may also comprise mono-tungsten carbide comprising particles having sizes capable of passing through 300 mesh or greater mesh sizes, in particular from 300 to 500 mesh (−300/+500 mesh). In this embodiment, the quantity of cemented carbide may be present in an amount of at least 25% by weight, based on the total weight of the carbide phase pre-application, in particular in the range of from 35 to 80% by weight, based on the total weight of the carbide phase, in particular from 45 to 75% w, on the same basis. The cast tungsten carbide may be present in an amount in the range of from 10 to 45% by weight, based on the total weight of the carbide phase, in particular from 15% w to 25% w, on the same basis. The mono-tungsten carbide may be present in an amount in the range of from 5 to 15% by weight, based on the total weight of the carbide phase, in particular from 8% w to 12% w, on the same basis.

In an exemplary embodiment, the hardfacing composition may comprise a carbide phase comprising mono-tungsten carbide in a quantity of at least 80% w, based on the total weight of the carbide phase, in particular at least 90% w, same basis. Alternatively, the hardfacing composition may comprise a carbide phase comprising cast tungsten carbide having a core of cast tungsten carbide and a shell of mono-tungsten carbide, as described above, in a quantity of at least 80% w, based on the total weight of the carbide phase, in particular at least 90% w, same basis. The carbide particles may be spherical or crushed in form. The carbide particles may have sizes in the range of from 80 to 200 mesh (−80/+200 mesh) pre-application. In this embodiment, the carbide phase may be present in an amount of from 60% w to 75% w or 67.5% w to 72.5% w, for example 70% w, based on the total weight of the hardfacing composition pre-application. The matrix may be present in an amount of from 25% w to 40% w or 27.5% w to 32.5% w, for example 25% w to 30% w.

In an exemplary embodiment, an intermediate layer may be used which may or may not be applied by a thermal spray process, as described above, and which comprises a material having a hardness that is less than the wear resistant material and any hardfacing composition that may be used. As used herein, such an intermediate layer may be termed a “buffer layer.” One or more of such intermediate layers may be used. The intermediate layer may be positioned adjacent the surface of the parent cutting element, between two wear resistant material layers, between two hardfacing layers, and/or between a hardfacing layer and a wear resistant material layer. The intermediate layer may be one of the at least two layers applied to a parent cutting element (i.e., the first intermediate layer). The intermediate layer may comprise a buffer material which may be selected from a metal alloy, a metal boride, and a metal phosphate. Metal alloys may be selected from iron-based alloys, aluminum-based alloys, nickel-based alloys, and combinations thereof. For example, a suitable nickel-based alloy may include nickel, chromium and boron (Ni—Cr—B) alloys. Examples of metal boride materials may include nickel boride or iron boride. Examples of metal phosphate materials may include nickel phosphate or iron phosphate. The intermediate layer may have a thickness of at least 0.025 mm (0.001 inches), in particular in the range of from 0.05 to 0.25 mm (0.002 to 0.01 inches). The buffer layer can be used for improved bonding of an adjacent layer and/or for reduced formation of impurities. For example, using a buffer layer between the surface of the parent cutting element and an adjacent layer of hardfacing can reduce dissolution and eta/oxide phase content in the hardfacing layer. For example, when a metal alloy is used in the buffer layer, the metal alloy and the matrix of the hardfacing composition may have a lower melting point than the material used to form the parent cutting element. Thus, less heat is required to apply the hardfacing layer resulting in less dissolution and eta/oxide phase content in the hardfacing.

In an exemplary embodiment, a second intermediate layer may be positioned between the first intermediate layer and the surface of the parent cutting element. The second intermediate layer may comprise a buffer layer, as described above. Alternatively, the second intermediate layer may comprise a wear resistant material applied using a thermal spray process, as described above. The wear resistant material comprises hard particles and a binder, as discussed above. Alternatively, the second intermediate layer may comprise a hardfacing composition, as discussed above. The material of the second intermediate layer may differ with respect to one or more properties from the parent element and the first intermediate layer. One or more properties may be selected from hardness, thickness, hard particle content, hard particle average grain size, toughness, composition, binder content, density, porosity, elastic modulus, microstructure, abrasion resistance, and erosion resistance. The difference in properties may provide a gradient there between. Alternatively, the difference in properties may provide for an interruption in properties. In this embodiment, there may be one or more additional intermediate layers positioned between the first intermediate layer and the parent cutting element. The one or more additional intermediate layers may comprise a wear resistant material, a hardfacing composition, or a buffer material, as described above, and differ with respect to one or more properties compared to the adjacent layers.

In an exemplary embodiment, a third intermediate layer may be positioned between the first intermediate layer and the outer layer. The third intermediate layer may comprise a buffer layer, as described above. Alternatively, the third intermediate layer may comprise a wear resistant material applied using a thermal spray process, as described above. The wear resistant material comprises hard particles and a binder, as discussed above. Alternatively, the third intermediate layer may comprise a hardfacing composition, as discussed above. The material of the third intermediate layer may differ with respect to one or more properties (as discussed above) from the first intermediate layer and the outer layer. The difference in properties may provide a gradient there between. Alternatively, the difference in properties may provide for an interruption in properties. In this embodiment, there may be one or more additional intermediate layers positioned between the first intermediate layer and the outer layer. The one or more additional intermediate layers may comprise a wear resistant material, a hardfacing composition, or a buffer material, as described above, and differ with respect to one or more properties compared to the adjacent layers.

In an exemplary embodiment, the layers applied to the parent cutting elements in the gage row may differ with respect to one or more properties from the layers applied to the parent cutting elements in the one or more inner rows and/or heel row. Additionally, the layers applied to the parent cutting elements in the innermost inner rows (i.e., nearest the nose of the cone) may differ with respect to one or more properties from the layers applied to the parent cutting elements in the outermost inner row (i.e., nearest the gage row). For example, wear resistant material applied as an outer layer to the parent cutting elements in the gage row may differ with respect to one or more properties from wear resistant material applied as an outer layer to the parent cutting elements in the one or more inner rows.

In an exemplary embodiment, the inner rows may comprise a plurality of parent cutting elements with layers applied thereto, one of which contains a wear resistant material applied by a thermal spray process which may or may not be subsequently sintered, while the gage row, and optionally the heel row, comprise inserts, such as TCIs, that are secured into the cone body. Alternatively, the gage row may comprise a plurality of parent cutting elements with layers applied thereto, one of which contains a wear resistant material applied by a thermal spray process which may or may not be subsequently sintered, while the inner rows, and optionally the heel row, comprise inserts, such as TCIs, that are secured into the cone body. Such inserts are discussed above.

Referring to FIG. 8, a milled tooth comprising four layers in accordance with an exemplary embodiment of the present disclosure is shown. As shown in FIG. 8, a milled tooth 414 includes a first intermediate layer 501, a second intermediate layer 503, a third intermediate layer 504, and an outer layer 502. The second intermediate layer 503 is positioned adjacent the surface of the milled tooth 414. The first intermediate layer 501 is positioned adjacent the second intermediate layer 503 and the third intermediate layer 504. The third intermediate layer 504 is positioned adjacent the outer layer 502. Although not drawn to scale, the thickness of the first intermediate layer 501h is greater than any one of the outer layer 502, the second intermediate layer 503, or the third intermediate layer 504. For example, the first intermediate layer 501h may comprise a hardfacing composition and the outer layer 502 and the third intermediate layer 504 may comprise wear resistant materials applied using a thermal spray process. The second intermediate layer 503 may comprise a buffer material. The hardfacing layer may comprise any of the hardfacing compositions described herein, for example a carbide phase containing a primary carbide of spherical cemented tungsten carbide-cobalt, a secondary carbide of crushed cast tungsten carbide, and a mono-tungsten carbide in an iron-based matrix. The wear resistant material of the outer layer 502 may comprise hard particles of mono-tungsten carbide and a binder of cobalt. The wear resistant material of the third intermediate layer 504 may also comprise hard particles of mono-tungsten carbide and a binder of cobalt; however, the wear resistant material of the third intermediate layer 504 differs with respect to one or more properties, as discussed herein such as cobalt content and/or average particle size of the mono-tungsten carbide, of the outer layer 502. Alternatively, the third intermediate layer 504 may comprise a buffer material which may be the same as used in the second intermediate layer 503 or may differ.

Referring to FIG. 9, a milled tooth comprising three layers in accordance with an exemplary embodiment of the present disclosure is shown. As shown in FIG. 9, a milled tooth 414 includes a first intermediate layer 501, a second intermediate layer 503, and an outer layer 502. The outer layer 502, the first intermediate layer 501, and the second intermediate layer 503 comprise wear resistant materials applied using a thermal spray process. Although not drawn to scale, the thickness of the second intermediate layer 503 is greater than the thickness of the first intermediate layer 501 which is greater than the thickness of the outer layer 502. However, the layers may have the same thickness or any variety of relative thicknesses. The wear resistant material of the outer layer 502, the first intermediate layer 501 and the second intermediate layer 503 contain hard particles and a binder, for example mono-tungsten carbide and cobalt. The wear resistant material of the first intermediate layer 501 differs with respect to one or more properties, as described herein such as cobalt content and/or average particle size of the mono-tungsten carbide, of the second intermediate layer 503 and the outer layer 502. The wear resistant material of the second intermediate layer 503 differs with respect to one or more properties, as described herein such as cobalt content and/or average particle size of the mono-tungsten carbide, of the first intermediate layer 501 and the outer layer 502. The wear resistant material of the outer layer 502 differs with respect to one or more properties, as described herein such as cobalt content and/or average particle size of the mono-tungsten carbide, of the first intermediate layer 501 and the second intermediate layer 503. Use of such a roller cone is believed to lead to an improvement in the performance of the drill bit by extending the bit life due to the improvement in wear resistance and/or toughness of the surface.

In these embodiments where at least two layers are applied, the layers may or may not be subsequently sintered. In those embodiments where the wear resistant layer(s) are sintered, such sintering may be performed after application of the wear resistant layer but before a subsequent layer may be applied or the sintering may be performed after application of all the layers.

In another embodiment, at least a portion of the bit, for example the bit leg (e.g., the shirttail section), may comprise a first intermediate layer of a hardfacing composition, as described above, and an outer layer of a wear resistant material applied by a thermal spray process, as described above. One or more additional intermediate layers may be used, as described above. The first intermediate layer and the outer layer are positioned on the same surface of the bit leg (i.e., the layers are placed one upon the other).

In another embodiment, at least a portion of the bit, for example the bit leg (e.g., the shirttail section), may comprise one or more layers, one layer comprising a wear resistant material applied by a thermal spray process and subsequently sintered, as discussed above.

In another embodiment, the rolling cone cutter may comprise a plurality of inserts and a plurality of parent cutting elements with a single layer comprising a wear resistant material applied to at least a portion thereof by a thermal spray process which may or may not be subsequently sintered. In one or more embodiments, at least one of the plurality of parent cutting elements may have at least two layers applied to at least a portion thereof wherein at least one of the layers comprises a wear resistant material applied by a thermal spray process which may or may not be subsequently sintered. The heel, gage or inner rows may contain parent cutting elements with a layer of wear resistant material. For example, one or more inner rows may comprise a plurality of parent cutting elements with a layer of a wear resistant material applied to at least a portion thereof by a thermal spray process which may or may not be subsequently sintered while the gage row, and optionally the heel row, comprises inserts, such as TCIs, that are secured into the cone body. Such inserts are discussed above. Alternatively, the gage row may comprise a plurality of parent cutting elements with a layer of a wear resistant material while the inner rows, and optionally the heel row, comprise inserts, such as TCIs, that are secured into the cone body. In some embodiments, the heel row may comprise a plurality of inserts; and one or more inner rows, and optionally the gage row, may comprise a plurality of parent cutting elements with a layer of a wear resistant material. Placement of the inserts and parent cutting elements may depend on the particular application. Suitably, the wear resistant material may be applied to the entire surface of the parent cutting element. Optionally, the wear resistant material may also be applied to the surface of the cone body. The wear resistant material may be a wear resistant material as described above. Use of such roller cones in a drill bit with strategically placed inserts and parent cutting elements may lead to an improvement in bit performance or a reduction in manufacturing costs.

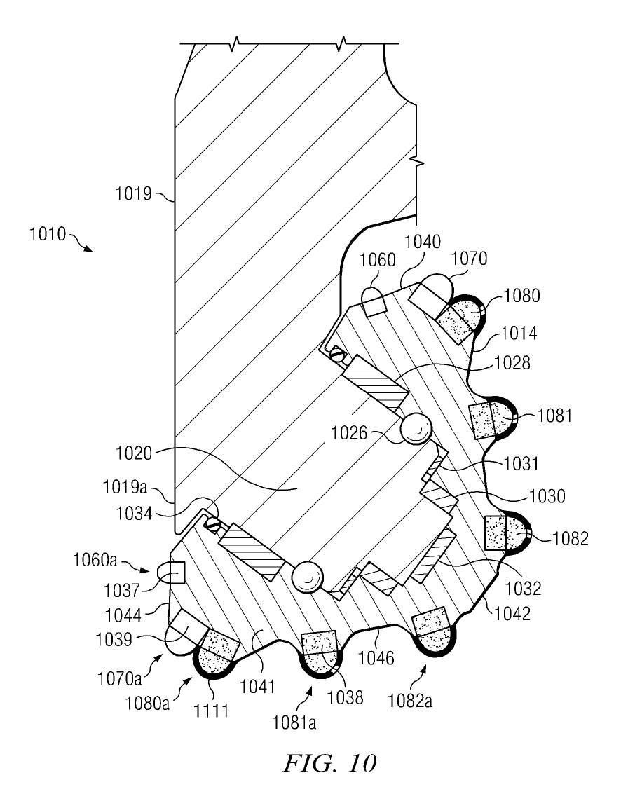

Referring now to FIG. 10, a portion of a earth boring roller cone bit according to an embodiment of the present disclosure is shown. Bit 1010 has a predetermined gage diameter as defined by three roller cone cutters 1014, 1015, 1016 (one of which is shown in FIG. 10) rotatably mounted on bearing journals (shafts or pins) that depend from the bit body. The bit body is composed of three sections or legs 1019 (one of which is shown in FIG. 10) that are welded together to form the bit body. Bit leg 1019 includes a shirttail portion 1019a.

The roller cone cutter 1014 is rotatably mounted on a pin or journal 1020 oriented generally downwardly and inwardly toward the center of the bit. The roller cone 1014 is typically secured on pin or journal 1020 by locking balls 1026. In the embodiment shown, radial and axial thrust are absorbed by roller bearings 1028, 1030, thrust washer 1031 and thrust plug 1032; however, the present disclosure is not limited to use in a roller bearing bit but may equally be applied in a friction bearing bit, where roller cones 1014-1016 would be mounted on journals 1020 without roller bearings 1028, 1030. In both roller bearing and friction bearing bits, lubricant may be supplied from a reservoir to the bearings by an apparatus that is omitted from the figures for the sake of clarity. The lubricant is sealed and drilling fluid excluded by an annular seal 1034. The roller cone cutter 1014 includes a back face 1040 and nose portion 1042. Further, the roller cone 1014 includes a generally frustoconical surface 1044 that is adapted to retain inserts 1060 that scrape or ream the sidewalls of the borehole as roller cones 1014-1016 rotate about the borehole bottom. Frustoconical surface 1044 will be referred to herein as the “heel” surface of roller cones 1014-1016.

Extending between the heel surface 1044 and nose 1042 is a generally conical surface 1046 having a plurality of parent cutting elements 1080, 1081, 1082 having a layer of wear resistant material 1111 applied by a thermal spray process (without subsequently sintering) to form wear resistant cutting elements that gouge or crush the borehole bottom as the roller cones 1014-1016 rotate about the borehole. Roller cone cutter 1014 includes a plurality of wear resistant cutting elements 1080, 1081, 1082 having a layer of wear resistant material applied by a thermal spray process, a plurality of gage row inserts 1070, and a plurality of heel row inserts 1060. Exemplary roller cone 1014 includes a plurality of heel row inserts 1060 that are secured in a circumferential heel row 1060a in the frustoconical heel surface 1044. Roller cone 1014 further includes a circumferential gage row 1070a of gage row inserts 1070 and circumferential inner rows 1080a, 1081a, 1082a comprising a layer of wear resistant material 1111 applied by a thermal spray process (without subsequently sintering) to parent cutting elements formed of a different material 1038 from the material of the cone body 1041, from the material of the gage row inserts 1039 and from the material of the heel row inserts 1037. Wear resistant cutting elements 1080-1082 each include a base portion and a cutting portion. Such heel row and gage row inserts have been discussed above. The gage row inserts 1070, 1039 and the heel row inserts 1060, 1037 may be formed from the same or different materials depending on the particular application. Roller cone 1014 further includes a plurality of inner row wear resistant cutting elements 1080-1082 which comprise a layer of wear resistant material 1111 applied by a thermal spray process (without subsequent sintering) to parent cutting elements the base portion of which is disposed within a mating socket drilled or otherwise formed in the cone body of roller cone cutter 1014 and arranged in spaced-apart inner rows 1080a, 1081a, 1082a, respectively. Each wear resistant cutting element 1080-1082 may be secured within the mating socket by any suitable means including without limitation an interference fit, brazing, or combinations thereof. Bit 1010 may include additional rows of inner row wear resistant cutting elements in addition to rows 1080a, 1081a, 1082a.

Inserts 1060, 1070 each include a base portion and a cutting portion. The base portion of each insert is disposed within a mating socket drilled or otherwise formed in the cone steel of a roller cone cutter 14-16. Each insert 1060, 1070 may be secured within the mating socket by any suitable means including without limitation an interference fit, brazing, or combinations thereof. The cutting portion of the inserts 1060, 1070 and wear resistant cutting elements 1080-1082 extends from the base portion of the insert/element and includes a cutting surface for cutting formation material. The cutting portion is depicted as a domed surface, however, a person of ordinary skill would appreciate that other configurations may also be used. The present embodiment will be understood with reference to one such roller cone 1014, roller cones 1015, 1016 (not shown) being similarly, although not necessarily identically, configured.

The following illustrates the improved properties of one or more embodiments of the present disclosure. In the following examples, hardfacing compositions “Composition A” and “Composition B” were used. The compositions contained a steel matrix and carbide phases which are summarized below in Table 1. Wear resistant material “Composition C” was also used and contained 88% w mono-tungsten carbide and 12% w cobalt. Composition C was WOKA 3101 powder commercially available from Sulzer Metco, Inc. In the following examples, the layers of hardfacing compositions had an approximate thickness of about 0.120 inches (3 mm) and the layers of wear resistant material had an approximate thickness of about 0.050 inches (1 mm).

TABLE 1
Carbide Phase Composition

| | | | Cemented Tungsten | Cemented Tungsten | Carburized | Deoxidizer | Quantity of |
|---|---|---|---|---|---|---|---|
| | Crushed Cast Tungsten | Crushed Cast Tungsten | Carbide Cobalt | Carbide Cobalt | Tungsten | and resin | Carbide |
| Compo- | Carbide (−40/+60 | Carbide (−40/+80 | Pellets*** (−16/+20 | Pellets*** (−30/+40 | Carbide (−400 | binder | Phase |
| sition | mesh) [% w]** | mesh) [% w]** | mesh) [% w]** | mesh) [% w]** | mesh)[% w]** | [% w]** | (% w)* |
| A | 27 | — | 35 | 24 | 10 | 4 | 67 |
| B | — | 18 | 40 | 28 | 10 | 4 | 67 |

*weight percent of the carbide phase is based on the total weight of the hardfacing composition (e.g., welding rod) pre-application: balance is iron-based binder alloy
**weight percent based on the total weight of the carbide phase pre-application
***the cemented tungsten carbide cobalt was non-super dense sintered tungsten carbide cobalt

In comparative example 1, coupon samples were hardfaced with Composition A using a welding rod comprising the carbide phase, as described in Table 1, and a mild steel AISI 1008 tube. The hardfacing composition was applied using an oxyacetylene welding process. The sample was then subjected to the high stress wear test according to the ASTM B611 protocols, which measures the wear resistance and toughness. This test was run again on a fresh coupon sample of Composition A. The average of the two results is summarized below in Table 2.

In comparative example 2, coupon samples were hardfaced with Composition B using a welding rod comprising the carbide phase, as described in Table 1, and a mild steel AISI 1008 tube. The hardfacing composition was applied using an oxyacetylene welding process. The sample was then subjected to the high stress wear test according to the ASTM B611 protocols. This test was run again on a fresh coupon sample of Composition B. The average result for the two tests is summarized below in Table 2.

In example 3, coupon samples were hardfaced with Composition A using a welding rod comprising the carbide phase, as described in Table 1, and a mild steel AISI 1008 tube. The hardfacing composition was applied using an oxyacetylene welding process. The coupon was then subjected to a high velocity oxygen liquid fuel thermal spray process to provide an outer layer of Composition C. The sample was then subjected to the high stress wear test according to the ASTM B611 protocols. This test was run again on a fresh coupon sample. The average result for the two tests is summarized below in Table 2.

In example 4, a coupon sample was subjected to a high velocity oxygen liquid fuel thermal spray process to provide a layer of Composition C. The sample was then subjected to the high stress wear test according to the ASTM B611 protocols. This test was run again on a fresh coupon sample. The average result for the two tests is summarized below in Table 2.

TABLE 2
B-611 Test Results

| Example | Wear Rate (cc/1000 rev) |
|---|---|
| 1 | 0.3490 |
| 2 | 0.3909 |
| 3 | 0.3081 |
| 4 | 0.2889 |

Examples 3 and 4 showed an improvement in toughness and wear resistance over comparative examples 1 and 2. In particular, coupon samples having a layer of wear resistant material applied via a thermal spray process showed a much better wear resistance/toughness than coupon samples without such a wear resistant material applied thereto. This improvement in wear loss can lead to an improvement in ROP and/or bit durability thus extending the life of the bit.

Additionally, in comparative example 5, coupon samples were hardfaced with Composition B as described in example 2. A coupon was subjected to a low stress test according to the ASTM G65 protocols, which measures wear resistance. This test measures the volume loss, and the lower the loss means better wear resistance. This test was run again on a fresh coupon sample of Composition B. The average result for the two tests is summarized below in Table 3.

In example 6, coupon samples were subjected to a high velocity oxygen liquid fuel thermal spray process with Composition C to provide a wear resistant material layer. A coupon was subjected to a low stress test according to the ASTM G65 protocols. This test was run again on a fresh coupon sample of Composition C. The average result for the two tests is summarized below in Table 3.

TABLE 3
G-65 Test Results

| Example | Wear Rate (cc (×10³)/1000 rev) |
|---|---|
| 5 | 2.72 |
| 6 | 1.75 |

Example 6 showed an improvement in wear resistance over comparative Example 5. In particular, coupon samples having a layer of wear resistant material applied via a thermal spray process showed a much better wear resistance than coupon samples with a hardfacing composition applied thereto.

Embodiments of the present disclosure may provide at least one of the following advantages: improved ROP; improved bit durability; improved cost-effectiveness; improved hardness; improved smoothness of the surface of the cutting elements (i.e., less surface roughness); ease of control of the coating process; improved consistency; environmentally friendly manufacturing process; and improved manufacturing process through automation of the thermal spray process.

Embodiments of the present disclosure may provide for a more cost effective roller cone cutter and bit by reducing the cost of materials, reducing the cost of labor, reducing the time required to manufacture, and/or simplifying the manufacturing process through the elimination of one or more manufacturing steps. The manufacturing process may also be more environmentally friendly as the wear resistant material may be applied by an automated process, thus, reducing operator exposure to the materials during processing.

Additionally, while the above embodiments make reference to discrete layers, no limitation is intended on the scope of the present disclosure by such a description. In fact, during application, materials at the interface may blend across the interface. Therefore, it is specifically within the scope of the present disclosure that there may be some blending of the multiple layers at the interface there between.

While the above embodiments have been described with layers applied to the surface of parent cutting elements such as generally conical-shaped bodies and milled teeth, no limitation is intended on the scope of the present disclosure by such a description. Additional cone surfaces may also have one or more layers applied thereto.

While the above embodiments have been described with each layer having a substantially uniform thickness, no limitation is intended on the scope of the present disclosure by such a description. It is intended to be included in the scope of the present disclosure that each layer may vary in thickness, for example the thickness of each layer may be greater on the leading surface that first engages the formation.

While the above embodiments have been described with reference to an oil well borehole, no limitation is intended on the scope of the present disclosure by such a description. It is intended to be included in the scope of the present disclosure that the roller cone cutters and drill bits incorporating such roller cones may be used in a variety of applications, for example mining, drilling water-wells, etc.

While the invention has been shown and described with respect to a limited number of embodiments, modifications thereof can be made by one skilled in the art without departing from the spirit or teaching herein. The embodiments described herein are exemplary only and are not limiting. For example, the roller cone drill bits have been described herein as having three roller cones; however, roller cone drill bits with one, two, or four roller cones is contemplated within the scope of the present disclosure. For example, the roller cone drill bits have been described herein as having cutting elements arranged in circumferential rows; however, such cutting elements may be arranged in non-circumferential rows such as spiral, multiple spirals, other patterns of offset cutting elements or random arrangements, such non-circumferential arrangements, as described in U.S. Pat. No. 7,370,711, are incorporated herein by reference in their entirety. Many variations and modifications of the system and apparatus are possible. Accordingly, the scope of protection is not limited to the embodiments described herein, but is only limited by the claims which follow, the scope of which shall include equivalents of the subject matter of the claims.

What is claimed is:

1. A method for manufacturing a roller cone for mounting on a drill bit comprising:
forming a cone which comprises a plurality of parent cutting elements spaced about the exterior surface of the body;
applying a layer of wear resistant material to at least a portion of at least one of the parent elements utilizing a thermal spray process; and
sintering the layer of wear resistant material.

2. The method of claim 1, wherein the thermal spray process is selected from a high velocity oxygen fuel process, a detonation gun process, and a super detonation gun process.

3. The method of claim 2, wherein the thermal spray process is a high velocity oxygen fuel spray process.

4. The method of claim 1, wherein the wear resistant material comprises hard particles and a binder, and wherein the hard particles are selected from the group consisting of carbides, borides, nitrides, and carbonitrides of W, Ti, Mo, Nb, V, Hf, Ta, and Cr, and wherein the binder is selected from the group consisting of cobalt, nickel, iron, mixtures, and alloys thereof.

5. The method of claim 4, wherein the hard particles further comprise one or more of boronitrides; diamond; and refractory metals.

6. The method of claim 4, wherein the hard particles comprise mono-tungsten carbide and the binder comprises cobalt.

7. The method of claim 1, wherein the layer of wear resistant material has a hardness of at least 80 Ra.

8. The method of claim 1, wherein a first plurality of parent elements are arranged in a circumferential gage row and a second plurality of parent elements are arranged in one or more circumferential inner rows, and wherein the first plurality of parent elements in the gage row and the second plurality of parent elements in the inner rows comprise a layer of a wear resistant material sintered to at least a portion of the parent elements, and wherein the layer of wear resistant material in the gage row differs with respect to one or more properties from the layer of wear resistant material in the inner rows.

9. The method of claim 8, wherein the one or more properties are selected from hardness, thickness, hard particle content, hard particle average grain size, toughness, composition, binder content, density, porosity, elastic modulus, microstructure, abrasion resistance, and erosion resistance.

10. The method of claim 1, wherein the cone comprises at least two layers of wear resistant material sintered to at least a portion of at least one of the parent elements, and wherein the at least two layers comprise an outer layer and a first intermediate layer positioned between the surface of the parent element and the outer layer, and wherein the first intermediate layer comprises a second wear resistant material, and wherein the first intermediate layer differs with respect to one or more properties from the outer layer.

11. The method of claim 10, wherein the wear resistant material of the outer layer and the second wear resistant material of the first intermediate layer comprise hard particles and a binder, and wherein the second wear resistant material comprises a different amount of binder from the wear resistant material of the outer layer.

12. The method of claim 10, wherein the wear resistant material of the outer layer and the second wear resistant material of the first intermediate layer comprise hard particles and a binder, and wherein the second wear resistant material comprises hard particles having a different average particle size from the hard particles of the wear resistant material of the outer layer.

13. The method of claim 1, wherein the sintering process utilizes temperatures in the range of from 900° C. to 1400° C.

14. The method of claim 1, wherein the sintering process utilizes pressures in the range of from 700 kPa to 11 MPa.

15. The method of claim 1, wherein the layer of wear resistant material has a thickness of at least 0.125 mm.

16. The method of claim 10, wherein the total thickness of the layers is at least 5 mm.

17. A roller cone for mounting on a drill bit prepared by the method as claimed in claim 1.

18. A drill bit comprising:
a bit body having at least one leg extending therefrom; and
a roller cone prepared by the method as claimed in claim 1 rotatably mounted on the leg.

19. A roller cone for mounting on a drill bit comprising:
a cone body which comprises a plurality of parent cutting elements having at least two layers applied on at least a portion of at least one of the parent elements, wherein
the at least two layers comprise an outer layer and a first intermediate layer positioned between the surface of the parent element and the outer layer; and
at least one of the at least two layers comprises a wear resistant material and is applied utilizing a thermal spray process.

20. The cone of claim 19, wherein the thermal spray process is a high velocity oxygen fuel spraying process which utilizes a liquid fuel.

21. The cone of claim 19, wherein the wear resistant material comprises hard particles and a binder, and wherein the hard particles are selected from the group consisting of carbides, borides, nitrides, and carbonitrides of W, Ti, Mo, Nb, V, Hf, Ta, and Cr, and wherein the binder is selected from the group consisting of cobalt, nickel, iron, mixtures, and alloys thereof.

22. The cone of claim 21, wherein the hard particles comprise tungsten carbide and the binder comprises cobalt.

23. The cone of claim 19, wherein the outer layer is applied utilizing the thermal spray process, and wherein the first intermediate layer is applied utilizing a process selected from the group consisting of oxyacetylene welding, plasma transferred arc, atomic hydrogen welding, tungsten inert gas welding, and gas tungsten arc welding, and wherein the first intermediate layer comprises a hardfacing composition comprising a matrix and a carbide phase which comprises one or more metal carbides.

24. The cone of claim 23, wherein the first intermediate layer comprises a hardfacing composition comprising a matrix and a carbide phase which comprises a cemented carbide and a cast tungsten carbide.

25. The cone of claim 24, wherein the cast carbide is present in a quantity of at least 10% by weight, based on the total weight of the carbide phase pre-application, and the cast carbide comprises particles having sizes in the range of from 30 to 80 mesh, pre-application.

26. The cone of claim 23, wherein the carbide phase comprises mono-tungsten carbide in a quantity of at least 80% w, based on the total weight of the carbide phase, and wherein the mono-tungsten carbide has a greater particle size than the wear resistant material.

27. The cone of claim 23, wherein the carbide phase comprises cast tungsten carbide having a core of cast tungsten carbide and a shell of mono-tungsten carbide in a quantity of at least 80% w, based on the total weight of the carbide phase, and wherein the cast tungsten carbide has a greater particle size than the wear resistant material.

28. The cone of claim 23, wherein the cone further comprises a second intermediate layer positioned between the first intermediate layer and the parent element, and wherein the second intermediate layer comprises a buffer material selected from a metal alloy, a metal boride, and a metal phosphate.

29. The cone of claim 19, wherein the cone further comprises a second intermediate layer positioned adjacent the surface of the parent element, and wherein the second intermediate layer comprises a hardfacing composition comprising a matrix and a carbide phase which comprises one or more metal carbides.

30. The cone of claim 19, wherein both the outer layer and the first intermediate layer are applied utilizing a thermal spray process and the first intermediate layer comprises a second wear resistant material which differs with respect to one or more properties from the wear resistant material in the outer layer.

31. The cone of claim 30, wherein the cone further comprises a second intermediate layer positioned between the first intermediate layer and the parent element, and wherein the second intermediate layer is applied utilizing a thermal spray process, and wherein the second intermediate layer comprises a third wear resistant material.

32. The cone of claim 31, wherein the wear resistant material in the outer layer, the second wear resistant material and the third wear resistant material comprise hard particles and a binder, and wherein the second wear resistant material comprises a different amount of binder from the wear resistant material in the outer layer and the third wear resistant material in the second intermediate layer.

33. The cone of claim 31, wherein the wear resistant material in the outer layer, the second wear resistant material and the third wear resistant material comprise hard particles and a binder, and wherein the second wear resistant material comprises hard particles having a different average particle size from the wear resistant material of the outer layer and the third wear resistant material of the second intermediate layer.

34. The cone of claim 31, wherein a gradient between the outer layer and the parent element is provided with respect to the one or more properties.

35. The cone of claim 19, wherein the cone further comprises a third intermediate layer positioned between the first intermediate layer and the outer layer, and wherein the third intermediate layer is applied utilizing a thermal spray process, and wherein the third intermediate layer comprises a wear resistant material which differs with respect to one or more properties from the wear resistant material in the outer layer.

36. The cone of claim 19, wherein the cone further comprises a third intermediate layer positioned between the first intermediate layer and the outer layer, and wherein the third intermediate layer comprises a buffer material selected from a metal alloy, a metal boride, and a metal phosphate.

37. The cone of claim 19, wherein the plurality of parent elements are arranged in a gage row and one or more inner rows, and wherein the outer layer of one or more of the plurality of parent elements in the gage row comprises a wear resistant material which differs with respect to one or more properties from a wear resistant material in the outer layer of one or more of the plurality of parent elements in the inner rows.

38. The cone of claim 19, wherein the layer of wear resistant material has a thickness of at least 0.125 mm.

39. The cone of claim 19, wherein the total thickness of the layers is at least 5 mm.

40. A method for manufacturing a roller cone for mounting on a drill bit comprising:
forming a cone which comprises a plurality of parent cutting elements;
applying a first intermediate layer to at least a portion of at least one of the parent elements; and
applying an outer layer, wherein at least one of the two layers comprises a wear resistant material which is applied utilizing a thermal spray process.

41. A drill bit comprising:
a bit body having at least one leg extending therefrom; and
a roller cone as claimed in claim 19 rotatably mounted on the leg.

42. A roller cone for mounting on a drill bit comprising a cone body which comprises a plurality of metal carbide inserts and a plurality of parent cutting elements having a layer of wear resistant material applied on at least a portion of at least one of the parent elements by a thermal spray process.

43. The cone of claim 42, wherein the plurality of metal carbide inserts are arranged in a gage row and the parent elements are arranged in one or more inner rows.

44. The cone of claim 42, wherein the plurality of metal carbide inserts are arranged in one or more inner rows and the parent elements are arranged in a gage row.

45. A method for manufacturing a roller cone for mounting on a drill bit comprising:
forming a cone which comprises a plurality of metal carbide inserts and a plurality of parent cutting elements; and
applying a layer of wear resistant material to at least a portion of at least one of the parent elements utilizing a thermal spray process.

46. A drill bit comprising:
a bit body having at least one leg extending therefrom; and
a roller cone cutter rotatably mounted on the leg, wherein at least a portion of the surface of the bit comprises a first intermediate layer and an outer layer; and wherein the first intermediate layer comprises a hardfacing composition applied utilizing a welding process and the outer layer comprises a wear resistant material applied utilizing a thermal spray process.

47. A drill bit comprising:
a bit body having at least one leg extending therefrom; and
a roller cone cutter rotatably mounted on the leg, wherein at least a portion of the surface of the bit comprises a layer of a sintered wear resistant material applied utilizing a thermal spray process.
